(19) United States
(12) Patent Application Publication
(10) Pub. No.: US 2009/0032547 A1
(43) Pub. Date: Feb. 5, 2009

(54) THREE BUTTON ACTUATED PILL HOLDER/DISPENSER

(76) Inventors: Theresa Litherland, Elkton, MD (US); Lizabeth London, Wynnewood, PA (US); Lawrence Kiey, Downington, PA (US); Debbie C. Heilman, Kennett Square, PA (US); David Trapani, West Chester, PA (US); Shaun Walsh, West Chester, PA (US); Juliet McQuillan, Wilmington, DE (US); Michael Forehand, Avondale, PA (US); Eric Christopher, Kennett Square, PA (US); Janice Jackson, Chaddsford, PA (US); Kathy Monday, Glen Mills, PA (US); Adele Gulfo, New York, NY (US); Elissa Budischak, Wilmington, DE (US); Tammi Gaskins, Wilmington, DE (US); Dipak Patel, New York, NY (US); Ryan Lynch, New York, NY (US); Jacqueline McSwiney, New York, NY (US); Thomas Parent, Cambridge, MA (US)

Correspondence Address: Weiss & Arons, LLP, 1540 Route 202, Suite 8, Pomona, NY, 10970, US

(21) Appl. No.: 11/831,899

(22) Filed: Jul. 31, 2007

(51) Int. Cl. G07F 11/00; G07F 9/00

(52) U.S. Cl. 221/7; 221/151; 221/152

(57) ABSTRACT

Systems and methods for providing a three button actuated pill holder/dispenser are provided. Such a pill holder/dispenser may include a housing comprising a plurality of apertures, a top button and two side buttons. In response to actuation of the top button, a pill may be dispensed from the pill holder/dispenser. Preferably, the two side buttons, which may project through the apertures, lock the top button, such that the top button may only be actuated when the two side buttons are depressed. Alternatively, some other sequence of the buttons may be implemented to cause a pill to be actuated. Additionally, the pill holder/dispenser may be packaged in a sealable package.

### BACKGROUND OF THE INVENTION

This application relates to a pill holder/dispenser. More specifically, this application relates to a pill holder/dispenser that may incorporate multiple safety features.

Many pill holders/dispensers incorporate multiple safety features. Nevertheless, there is always a trade-off between greater safety and ease-of-use.

It would be desirable to incorporate one or more safety features into a pill holder/dispenser without substantially adversely affecting the ease-of-use of the holder/dispenser.

### SUMMARY OF THE INVENTION

It is an object of the invention to incorporate one or more safety features into a pill holder/dispenser—alternatively referred to herein as a pill container—without substantially adversely affecting the ease-of-use of the holder/dispenser.

A pill holder/dispenser according to the invention is provided. The pill holder/dispenser includes a housing comprising a plurality of apertures and a top button. In response to actuation of the top button a pill is caused to be dispensed from the pill holder/dispenser. The pill holder/dispenser also includes two side buttons. The side buttons may project through the apertures in the housing. Furthermore, the side buttons lock the top button such that the top button may only be actuated when the two side buttons are depressed.

It should be noted that invention may includes a pill holder/dispenser and pills inside such a dispenser. Such pills according to the invention may be any pills that are specified in die FDA Orange Book for approved medications.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a perspective view of a pill holder/dispenser according to the invention in a sealable plastic tray;

FIG. 2A is a front view of a pill holder/dispenser according to the invention;

FIG. 2B is a top view of the pill holder/dispenser according to the invention;

FIG. 3 is a perspective view of a pill holder/dispenser according to the invention;

FIG. 4 is a perspective view of a partially open pill holder/dispenser according to the invention;

FIG. 5A is a first cut-away side view of a portion of a pill holder/dispenser according to the invention;

FIG. 5B is a second cut-away side view of a portion of a pill holder/dispenser according to the invention; and

FIG. 5C is a third cut-away side view of a portion of a pill holder/dispenser according to the invention.

### DETAILED DESCRIPTION OF THE INVENTION

The invention is directed to a pill container that may dispense pills in response to actuation of three buttons in a predetermined sequence. In one embodiment of the invention, the sequence may require depressing two side buttons in order to unlock a top button. Thereafter, or substantially simultaneously thereto, the top button may be actuated and, in response, a pill may be dispensed. When a pill is dispensed, certain embodiments of the invention preferably cause a counter to be changed such that the number of pills that have been dispensed is recorded.

One embodiment of the invention includes a pill hook that restrains the pill from exiting an aperture in a housing of the holder until the top button is actuated. Before the top button is actuated, a distal edge of the pill hook forms a narrow corridor with a projection on the internal portion of the housing of the pill holder/dispenser. As long as the top button is not actuated, this corridor is too narrow for the pill to pass through. When the top button is actuated, the distal end of the pill hook moves away from the projection and, in one embodiment of the invention, widens the pill corridor within the housing. The wider corridor allows the pill to move below the projection, into a cavity in the housing, and then to be ejected out of the aperture in the housing.

In certain embodiments of the invention, the housing may be formed to incorporate a cartridge that is adapted to he pulled out and refilled with pills. Alternatively, the cartridge may be sealed within the housing such that the pill holder/dispenser is a disposable item that is filled with a certain predetermined number of pills and discarded after use. In such embodiments, a number of such disposable packages may be combined in a single aggregation or package to provide a certain predetermined dose over a period of time that extends longer than the number of pills in a single package is adapted to contain.

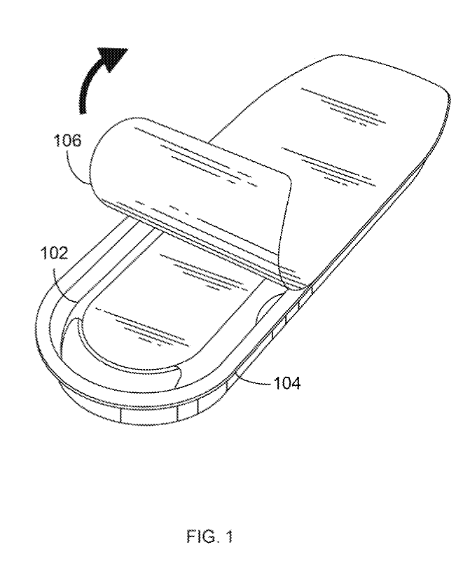

FIG. 1 is a perspective view of a pill holder/dispenser 102 according to the invention in a sealable plastic tray 104. The pill holder/dispenser according to the invention may serve to hold pills and to provide a mechanism for dispensing the pills at a predetermined rate—e.g., a certain number of pills per button actuation—in response to a predetermined action.

Tray 104 may be covered by aluminum cover 106. It should be noted that cover 106 may be implemented with any suitable material. In this embodiment, sealable plastic tray 104 and cover 106 may aid stability of the stored pill holder/dispenser. Furthermore, an embodiment of the invention including cover 106 may provide additional space for showing information relating to the packaged device and/or medication.

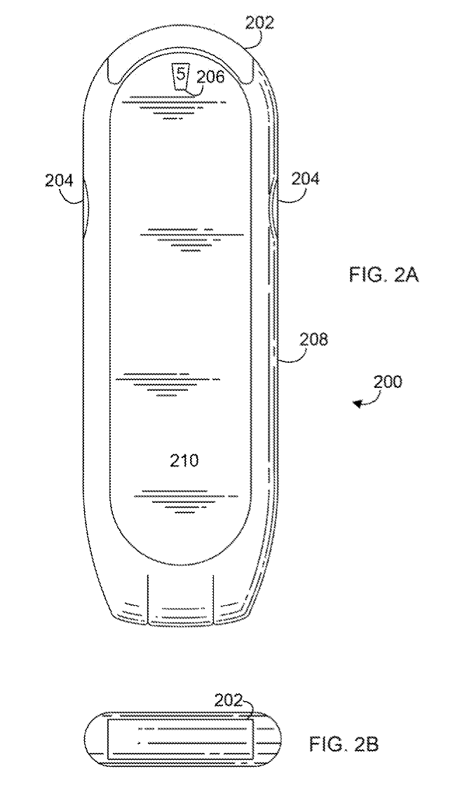

FIG. 2A is a front view of a pill holder/dispenser 200 according to the invention. Pill holder/dispenser 200 preferably includes top button 202, side buttons 204, counter 206, housing 208 (which may be formed from a translucent material), and flat front surface 210 (which may serve as additional space for labeling content).

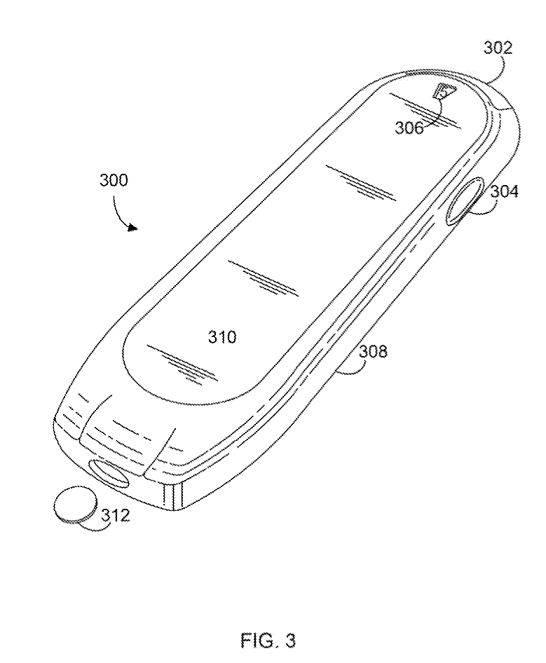

FIG. 2B is a top view of the pill holder/dispenser according to the invention. FIG. 2B shows top button 202. Top button 202 may be sufficiently wide as to allow easy actuation when the side buttons (see FIG. 3) have been depressed.

FIG. 3 is a perspective view of a pill holder/dispenser 300 according to the invention. Holder/dispenser 300 preferably includes top button 302, side buttons 304, counter 306 and flat front panel 310. In one embodiment of the invention, top button 302 can only be depressed when both of side buttons 304 are depressed. In order to dispense pill 312, one hand can be used to depress side buttons 304. This is an important safety feature because it may, in one embodiment of the invention, require substantially simultaneously depressing three buttons, said buttons having been depressed in a predetermined order, to dispense a pill. In alternative embodiments of the invention, top button 302 may only be depressed when side buttons 304 have been depressed in a certain predetermined order or sequence such as one after the other.

Furthermore, in certain embodiments of the invention, counter 306 may only be actuated when top button 302 is actuated. As such, counter 306 is only actuated when a pill is dispensed from holder/dispenser 300. FIG. 3 also shows a substantially flat front panel 310 upon which labeling Information can be provided.

The holder/dispenser in FIG. 3 is notable as it shows that housing 302 may be formed using a translucent material. Such a material provides visibility to the contents of holder/dispenser 300. Such visibility may provide another visual indicator (in addition to the counter) of the number of number of remaining pills in holder/dispenser 300.

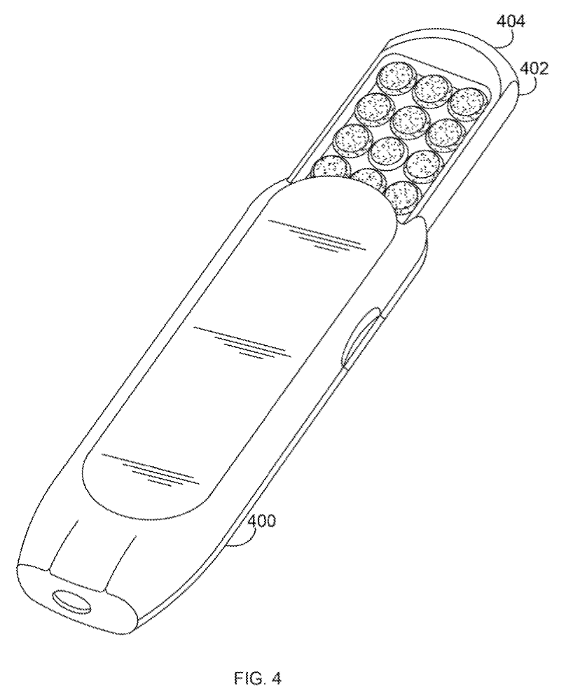

FIG. 4 is a perspective view of a partially open pill holder/dispenser 400 according to the invention. Pill holder/dispenser 400 includes pill bed cartridge 402 (which may incorporate top button 404), as well as multiple rows of pills such as, in one exemplary embodiment, three rows of 10 pills each.

While holder/dispenser 400 is shown with a removable cartridge 402, nevertheless holder/dispenser may be formed as a unitary, sealed, preferably disposable device. As such, a user would not have access to the cartridge but would be presented with a number of disposable devices according to the invention, each of which incorporates a certain number of pills or other appropriate medicines.

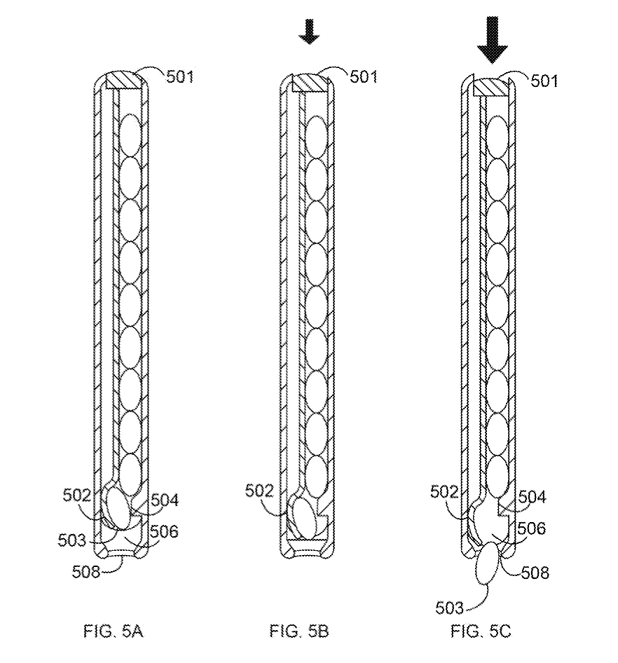

FIG. 5A is a first cut-away side view of a portion of a pill holder/dispenser housing 500 according to the invention. FIG. 5A shows pill hook 502, pills 503, projection 504, cavity 506 and aperture 508. FIG. 5A shows pill hook in a first, pre-actuated—i.e., undeployed—position. In this position, the distal end of hook 502 prevents pills 503 from exiting aperture 508 via cavity 506 by enclosing a space with projection 504 that is smaller than pill 503. As such, pills 503 are securely stored in housing 500.

FIG. 5B is a second cut-away side view of a portion of pill holder/dispenser housing 500 according to the invention. FIG. 5B shows pill holder/dispenser housing 500 following the initiation of the actuation of pill hook 502. Downward actuation of pill hook 502 may preferably be accomplished by pressing top button 501. Nevertheless, the shape of pill hook 502—i.e., a hooked distal end and straight proximal portion—prevents the remaining pills from entering cavity 506.

When pill hook 502 is actuated in a downward motion with respect to housing 500, the open portion of hook 502 moves downward with respect to projection 504 and engages a portion of cavity 506. As a result, pill 503 begins to fill cavity and to pass by projection 504. In this sense, the pill channel is moving down, and opening as the top button is pressed.

FIG. 5C is a third cut-away side view of a portion of pill holder/dispenser 500 according to the invention. FIG. 5C shows that cavity 506 has been expanded to accommodate pill 503. Thereafter, pill 503 may slide through aperture 508 and be ejected from housing 500.

With respect to FIGS. 5A-5C, it should be noted that the side buttons that prevent the depression of the top button are not shown in order to better schematically illustrate the effect of depressing top button 501 on the action of pill hook 502.

The three stages shown in FIGS. 5A-5C are exemplary of a device and method according to the invention. In these three steps, a pill may be ejected from a housing according to the invention using a three-button actuation system. The three-button actuation system provides an added safety feature according to the invention because it requires multiple coordinated actions on the part of the user. The three-button system adds an ease-of-use feature at least because it may be operated using one hand. The counter system that only counts the dispensing of a pill when a pre-selected or predetermined button is depressed also acts as a safety feature because it shows the user the number of pills currently in the pill holder/dispenser.

In alternative embodiments of the invention, the pill attributes such as various pill metrics including height, width, and depth may drive the overall size of the actual device. Additionally, the “counting” functionality may be customized for a particular brand need. Furthermore, the dispensing mechanism as disclosed herein may be tailored to a pill form factor.

One additional feature of the invention includes the sealable pack which may provide stability and protection from collision issues. Finally, the flat areas provide significant brand billboards for brand identification.

Thus, systems and methods for according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A pill holder/dispenser comprising:
a housing comprising a plurality of apertures;
a top button, the top button that, in response to actuation thereof, causes a pill to be dispensed from the pill holder/dispenser; and
two side buttons, said side buttons that project through the apertures, the two side buttons that lock the top button, wherein the top button may only be actuated when the two side buttons are depressed.

2. The pill holder/dispenser of claim 1 further comprising a pill hook that restrains a pill from being dispensed when the top button is in an undeployed position.

3. The pill holder/dispenser of claim 2 further comprising a projection that acts together with the hook to restrain a pill from being dispensed when the top button is in an undeployed position.

4. The pill holder/dispenser of claim 1 further comprising a removable cartridge that includes the top button and that is adapted to house a plurality of pills.

5. The pill holder/dispenser of claim 1 wherein said housing is formed from a translucent material.

6. The pill holder/dispenser of claim 1 further comprising a counter.

7. The pill holder/dispenser of claim 6 wherein the counter is coupled to the top button such that the counter counts when the top button is actuated.

8. The pill holder/dispenser of claim 1 wherein the top button comprises a width that is greater than half the width of the housing.

9. A pill container comprising:
a housing comprising a plurality of apertures;
a top button,
two side buttons, said side buttons that project through the apertures, wherein the pill container dispenses a pill in response to actuation of the three buttons in a predetermined sequence; and
a pill hook that restrains a pill from being dispensed when the top button is not actuated.

10. The pill container of claim 9 further comprising a projection that acts together with the pill hook to restrain a pill from being dispensed when the top button is not actuated.

11. The pill container of claim 9 further comprising a removable cartridge that includes the top button and that is adapted to house a plurality of pills.

12. The pill container of claim 9 wherein said housing is formed from a translucent material.

13. The pill container of claim 9 further comprising a counter.

14. The pill container of claim 13 wherein the counter is coupled to the top button such that the counter counts only when the top button is actuated.

15. The pill container of claim 9 wherein the top button comprises a width that is greater than half the width of the housing.

16. A method for packaging a pill container, said pill container comprising a housing comprising a plurality of apertures, a top button, and two side buttons, said side buttons that project through the apertures, the two side buttons that lock the top button, wherein the pill container dispenses a pill in response to actuation of the three buttons in a predetermined sequence, said method comprising:
forming a sealable package which can accommodate the pill container;
inserting the pill container in the sealable package; and
sealing the package with the pill container inserted therein.
